(19) United States
(12) Patent Application Publication
(10) Pub. No.: US 2010/0239775 A1
(43) Pub. Date: Sep. 23, 2010

(54) APPLICATIONS FOR SCANNING TUNNELLING MICROSCOPY

(75) Inventors: Chunqing Zhou, Bavaria (CA); Sharon G. Roscoe, Wolfville (CA)

Correspondence Address: Milstein Zhang & Wu LLC, 49 Lexington Street, Suite 6, Newton, MA, 02465-1062, US

(73) Assignee: The Governors of Acadia University

(21) Appl. No.: 12/602,311

(22) PCT Filed: May 28, 2008
(86) PCT No.: PCT/CA08/01004

§ 371 Date: Jun. 3, 2010

Related U.S. Application Data
(60) Provisional application No. 60/932,381, filed on May 31, 2007.

(51) Int. Cl. G01Q 60/10; B01J 19/08

(52) U.S. Cl. 427/457; 850/62

(57) ABSTRACT

In the present invention, it has been discovered that Scanning Tunneling Microscopy is a useful tool for imaging a surface on a nanometer scale and/or fabricating on a nano-sized scale by transferring a particle (e.g., protein) from one location to another. This is accomplished by a method of transferring a material from a first location to a second location comprising the steps of providing a stylus, applying a bias to the stylus, providing a surface, and changing the bias of the stylus such that the material is transferred from the first location to the second location.

### CROSS-REFERENCE TO RELATED APPLICATIONS

This application claims the benefit of priority from U.S. provisional application Ser. No. 60/932,381 filed May 31, 2007.

### FIELD OF THE INVENTION

This invention relates to scanning tunneling microscopy in general, and the use of scanning tunneling microscopy to transfer particles from one location to another in particular.

### BACKGROUND OF THE INVENTION

Nanofabrication is the design and manufacture of devices with dimensions measured in nanometers, or units measuring 10⁻⁹ meters. Nanofabrication has potential applications in many fields such as computer and/or electronic technologies, aerospace technologies, and medical and/or biotechnologies. For example, nanofabrication techniques have the potential to offer super-high-density microprocessors and memory chips that could advance computer and computer-related technologies.

There are several ways that nanofabrication might be done. One traditional method involves nanolithography. Nanolithography is the process of etching, writing, or printing at the microscopic level, where the dimensions of characters are on the order of nanometers. For example, individual atoms may be manipulated using the tip of a scanning tunneling microscope (STM). However, the utility of STM in nanofabrication techniques is traditionally limited to the manipulation of atoms and small inorganic molecules such as Xe, CO, metal atom clusters, or metal nanoparticles commonly having diameters greater than 10 nanometers, such as gold nano-particles or silver nanoparticles.

Nanoscale substances can also be transferred from one point to another using a scanning probe microscope (SPM). Korean Application No. 10-2004-0094982 discloses the use of a scanning probe microscope to transfer a substance from the SPM tip to a surface. The SPM tip is submerged in a solution having a voltage potential, which results in the SPM having a bias voltage that is opposite the polarity of the target substance in the solution. The bias voltage enables the substance to be collected onto the tip. The substance is then transferred to a desired surface in a wet state and before the tip contacts the surface the tip bias is removed. By this method, substances are deposited imprecisely and necessarily densely since deposition occurs due to capillary action upon the SPM tip contacting the surface. Therefore, the number of particles and the precise location of deposition cannot be controlled using this method.

### SUMMARY OF THE INVENTION

In one aspect, the present invention provides methods of selectively transferring nano-sized material from one location to another using STM where the number of particle material and the location of deposition can be precisely controlled by varying the polarity of the potential, pulse period, and the clearance between the STM tip and a surface. These methods include providing a stylus having a bias, providing the material, providing a surface, and changing the bias of the stylus such that the material transfers from one location to another.

One aspect of the present invention provides methods of using a STM to selectively transfer at least one particle from one location to another by providing a stylus having a bias, providing a surface, providing at least one particle, and changing the bias of the stylus such that at least one particle transfers from one location to another.

Another aspect of the present invention provides methods of using a STM to selectively transfer at least one protein molecule from one location to another by providing a stylus having a bias, providing a surface, providing at least one protein molecule, and changing the bias of the stylus bias such that at least one protein molecule transfers from one location to another.

Another aspect of the present invention provides methods of creating a design on a surface by transferring at least one protein from a stylus to the surface. This transfer is accomplished by providing a stylus having a bias, providing at least one protein, providing a surface, and changing the bias of the stylus bias such that a single protein transfers from the stylus to the surface.

Another aspect of the present invention provides the removal of at least one protein from a surface using a STM, by providing a stylus having a bias, providing a surface, providing at least one protein on the surface, wherein the bias has a magnitude and polarity sufficient to transfer at least one protein from the surface to the stylus when the stylus is raster scanned over the surface.

Another aspect of the present invention provides the removal of a single protein from a surface using STM, by providing a stylus having a bias, providing a surface, providing a protein on the surface, and changing the bias of the stylus such that the protein is transferred from the surface to the stylus.

### BRIEF DESCRIPTION OF THE DRAWINGS

FIG. 1 is an STM-generated image of an annealed gold surface without any particles;

FIG. 2 is an STM-generated image of an annealed gold surface on which single β-LG molecules are deposited in accordance to one embodiment of the present invention;

FIG. 3 is an STM-generated image of a gold surface printed with the design “CACN” in accordance to one embodiment of the present invention;

FIG. 4 is an STM-generated image of a gold surface printed with the design “ACMA” in accordance to one embodiment of the present invention; and

FIG. 5 is an STM-generated image of a gold surface having a partially erased “ACMA” design in accordance to one embodiment of the present invention;

FIG. 6A is an STM-generated image of a gold surface having three nano-patterns of β-LG molecules deposited in accordance to one embodiment of the present invention;

FIG. 6B is an STM-generated image of a gold surface having a series of nano-patterns of β-LG molecules deposited in decreasing potential in accordance to one embodiment of the present invention;

FIG. 7 is an STM-generated image of a gold surface having nano-patterns deposited in overlap and deposited separately in accordance to one embodiment of the present invention;

FIG. 8A is an STM-generated image of a gold surface having a long nano-band deposited in accordance to one embodiment of the present invention;

FIG. 8B is an STM-generated image of a gold surface having a wide nano-band depositing in accordance to one embodiment of the present invention;

FIG. 9A is an STM-generated image of a gold surface having four nano-patterns of multiple β-LG molecules deposited in accordance to one embodiment of the present invention; and

FIG. 9B is an STM-generated image of a gold surface having a series of nano-patterns of multiple β-LG molecules deposited in accordance to one embodiment of the present invention.

### DETAILED DESCRIPTION OF THE INVENTION

### I. Definitions

As used herein, a “protein” or “protein molecule” is an organic compound made of amino acids arranged in a linear chain and joined together by peptide bonds between the carboxyl and amino groups of adjacent amino acids. Examples of proteins include β-lactoglobulin (β-LG), bovine serum albumin (BSA), lysozyme, or immunoglobin G (IgG).

As used herein, a “stylus” or “tip” is an atomically sharp probe for use in scanning tunneling microscopy, which when electrically charged and brought sufficiently close to a surface, can deliver a tunneling current between the conducting or semiconducting surface atoms and the tip.

As used herein, “biomolecule” refers to protein, DNA, RNA, or other biological compounds and mixtures thereof. Protein is defined above.

As used herein, a “surface” is the outer or the topmost boundary of an object or a material layer constituting such a boundary. A surface can comprise any plane or contour. Surfaces suitable for the present invention are those surfaces that are capable of being scanned using STM. For example, these surfaces are semiconducting or conducting.

A “bias” or “voltage bias” is a steady state voltage. A “change in bias” or “changing the bias” refers to a change or the act of changing the magnitude and/or polarity of a bias. The change lasts for a duration sufficient to transfer at least one particle from one location to another (e.g., the duration can be extended, i.e., lasting 1 second or longer, or temporary, i.e., lasting for less than 1 second). For example, a bias may undergo a change in magnitude and polarity that lasts for a fraction of a second (e.g., from about 0.001 milliseconds to about 10 milliseconds, from about 0.75 milliseconds to about 1.25 milliseconds, or from about 0.9 milliseconds to about 1.1 milliseconds.) In another example, a bias is changed from about +0.5V to about −0.5V for a period of about 1 millisecond (e.g., from about 0.5 milliseconds to about 1.5 milliseconds). Another example of a change in bias includes changes in bias within the range +5.0 V to about −5.0 V.

As used herein, “conductive material” is any material that conducts electric current when an electrical potential difference is applied across two different points on the material. Exemplary conductive materials include conductors and semi-conductors. Other exemplary conductive material includes metals (e.g., copper, iron, gold, silver, platinum, palladium, ruthenium, rhodium, osmium, iridium, zinc, nickel, aluminum, silver, titanium, mercury, chromium, cadmium, alloys thereof, and the like), graphite, solutions of salts, plasmas, some glasses (e.g., silicon), or conducting or semiconducting polymers.

As used herein, “STM” refers to a scanning tunneling microscope or scanning tunneling microscopy.

As used herein, “material” refers to at least one particle, at least one biomolecule, and/or at least one protein molecule. For example, ‘material’ refers to a single particle or a plurality of particles. In another example, material refers to a single protein molecule or a plurality of protein molecules, where the protein molecules may be of the same kind (e.g., chemically identical protein molecules) or of a different kind (e.g., chemically different protein molecules).

As used herein, “transferring” or “transfer” means conveying material (e.g., at least one particle (e.g., at least one atom, at least one ion, at least one molecule (e.g., biomolecule), or the like)) from one place to another. For example, ‘transferring’ can describe conveying at least one particle (e.g., at least one protein molecule) from a stylus to a surface or conveying at least one particle (e.g., at least one protein molecule) from a surface to a stylus.

As used herein, “selectively transferring” refers to the transfer of a particle from a desired location to another desired location. Transferring is defined above.

As used herein, “particle” refers to an atom, an atom cluster, i.e., a non-covalently bonded group of atoms), or a molecule (e.g., a biomolecule, (e.g., a protein molecule, DNA, or RNA)).

### II. STM Technology

In the present invention, it has been discovered that Scanning Tunneling Microscopy is a useful tool for fabrication on a nano-sized scale by selectively transferring material (e.g., at least one particle (e.g., at least one protein)) from one location to another location.

STM employs a stylus that has been treated so that it has an atomically sharp tip. When a potential difference is applied to a stylus and the stylus is brought sufficiently close to a surface, a tunneling current flows between the surface and the stylus. The tunneling current (I) is measured from the variation in the bias voltage, or bias, (U) between the stylus and the surface at the measurement point. The tunneling current I can be expressed as:

I=K×U×e^{-(k×d)} (1)

where K and k are constants, U is the tunneling bias, and d is the distance between the stylus and the surface. Based on the relationship expressed in equation (1), the tunneling current is directly dependent on the bias, U, and the distance between the stylus and the surface, d. Furthermore, the tunneling current undergoes exponential decay as the distance between the stylus and the surface increases. At a separation of a few atomic diameters, the tunneling current rapidly increases as the distance between the stylus and the surface decreases when the stylus maintains a constant bias. This rapid change of tunneling current with distance results in atomic resolution when the tip is raster scanned over the surface to produce an image.

However, the present invention employs STM to selectively transfer material from one location to another location. This method is useful for creating a nanometer-scaled design on a surface by selectively depositing material (e.g., protein molecules) or by selectively removing material (e.g., protein molecules) from a surface.

### III. Transferring Particles Using STM

The methods of the present invention are useful for selectively transferring material from a first location to a second location comprising providing a stylus having a bias, providing a surface, providing material, and changing the bias of the stylus such that material is transferred from the first location to the second location, wherein the material comprises at least one particle (e.g., at least one protein molecule).

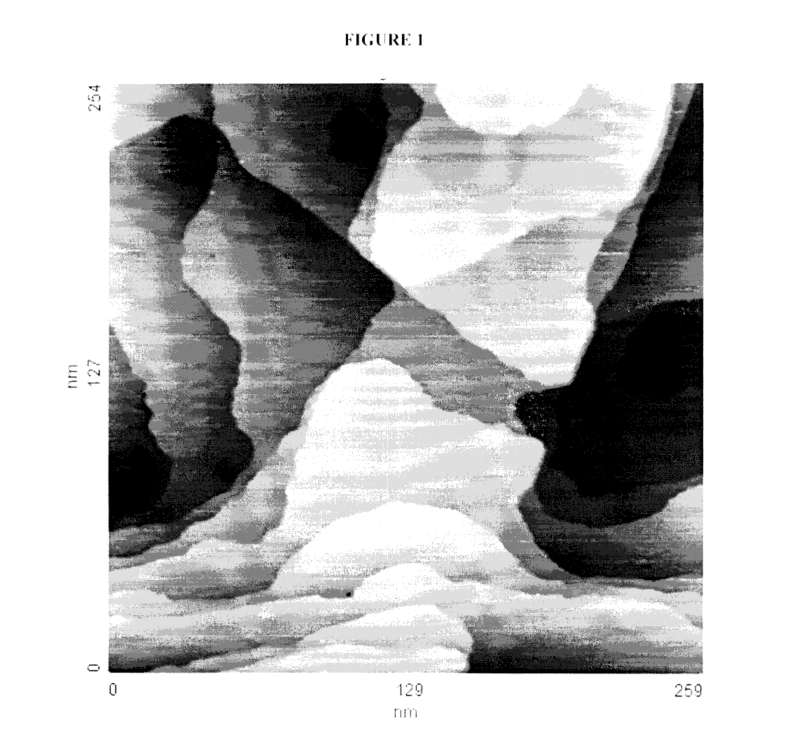

As shown in FIG. 1, an annealed gold surface without any particles deposited onto it appears as smooth terraces. The β-lactoglobulin (β-LG) particles were removed or erased from the surface by scanning the surface with the (β-LG-coated stylus with the stylus bias set to +0.5 V (surface as reference).

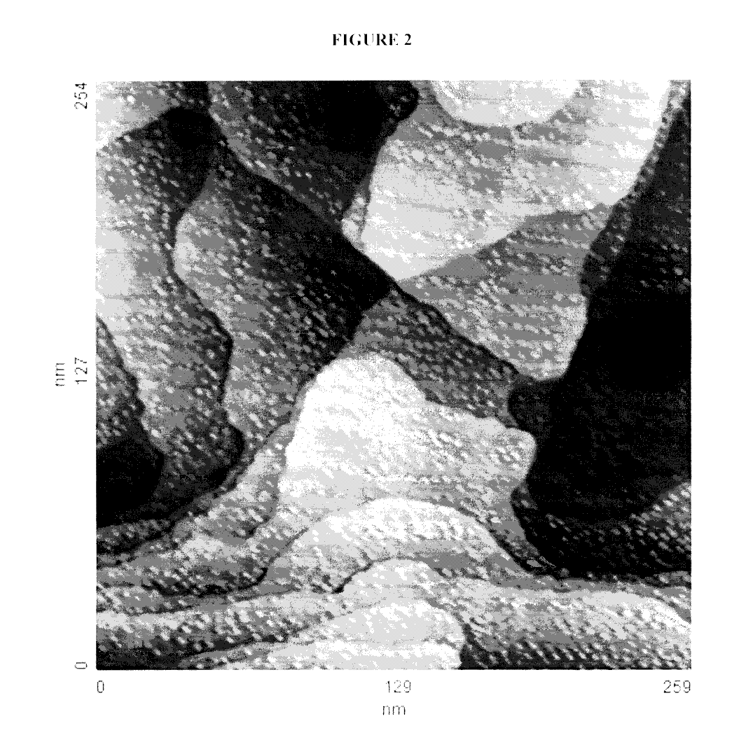

Reversing the stylus bias to −0.5 V (surface as reference) causes particles such as β-LG to be deposited onto the annealed gold surface. As shown in FIG. 2, scanning the surface with the β-LG-coated stylus biased to −0.5 V (surface as reference) results in single β-LG molecules being deposited evenly onto the gold surface from the stylus when the stylus is raster scanned over the gold surface.

It is also a feature of the present invention that the amount of material transferred (e.g., at least one particle (e.g., at least one protein molecule)) and the precision of material deposition is tunable approximately in accordance with the relationship expressed in equation (1) above. Thus, the amount of material transferred and the precision with which it is transferred can be adjusted by changing the bias and/or changing the distance between the stylus and the surface. For example, when the distance between the surface and the stylus, i.e., clearance, is increased by about 0.1 nm, and the bias undergoes a given change, a plurality of particles can be deposited onto a surface. However, when the distance between the surface and the stylus is increased by about 0.5 nm, and the bias undergoes the same change, a single particle can be deposited onto the surface.

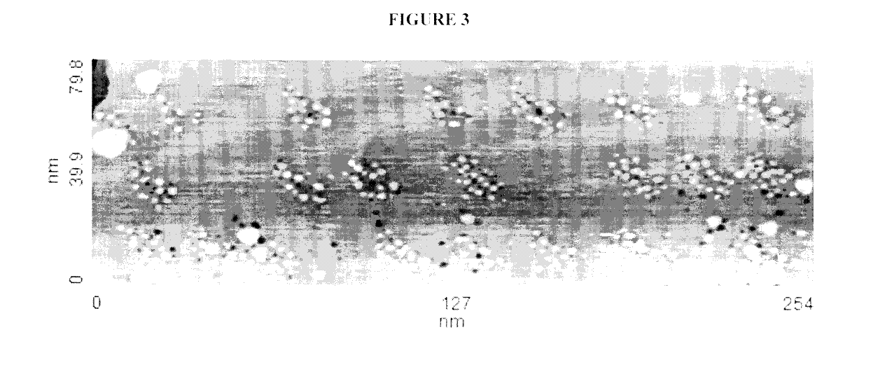

Surfaces can also be printed with a desired design (FIGS. 3-5). Furthermore, the number of molecules deposited and the location of deposition can be selected by controlling the bias potential and the pulse duration. In FIG. 3, a gold surface was printed with the design “CACN” using bias pulses of −3.0 V and 1 millisecond pulse duration, where each nanopattern consists of about a dozen β-LG molecules. Each letter in the string “CACN” fabricated or written with small nanopatterns are only 70 nm in height. Each pattern consisting of several single molecules was smaller than 20 nm.

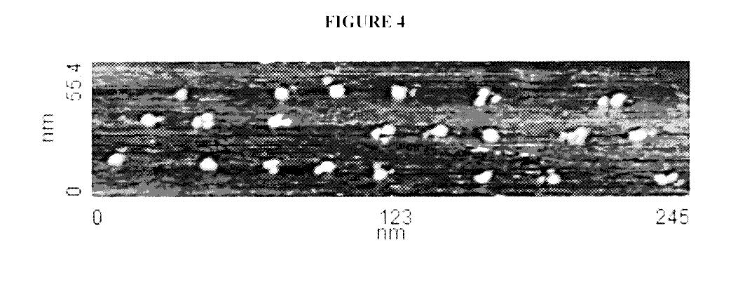

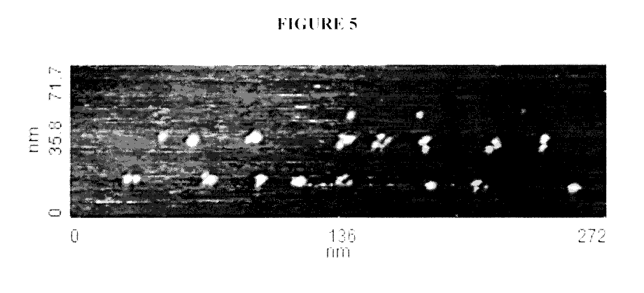

In FIG. 4, a gold surface was printed with the design “ACMA” using bias pulses of −3.2 V and 1 millisecond pulse duration, where each nanopattern consists of one or a couple of β-LG molecules, forming characters no more than 40 nm in height. Subsequently scanning a desired location on the gold surface using a reversed bias potential will erase the design. Shown in FIG. 5 is another printed gold surface with an “ACMA” design where subsequently the upper portion of the design has been erased.

One aspect of the present invention provides a method of selectively transferring at least one particle from a first location to a second location comprising providing a stylus having a bias, providing a surface, providing at least one particle, and changing the bias of the stylus such that at least one particle transfers from the first location to the second location.

Another example provides a method of selectively transferring at least one protein molecule from a first location to a second location comprising providing a stylus having a bias, providing a surface, providing at least one protein molecule, and changing the bias of the stylus such that at least one protein molecule transfers from the first location to the second location.

In several examples, STM is used to selectively deposit at least one particle (e.g., at least one protein molecule) on a surface or selectively remove at least one particle (e.g., at least one protein) from a surface by changing the bias of the stylus, such that at least one particle (e.g., at least one protein molecule) is transferred from the stylus to a selected location on the surface or at least one particle (e.g., at least one protein molecule) is transferred from a selected location on the surface to the stylus. In one example, at least one particle (e.g., at least one protein molecule (e.g., β-LG, BSA, lysozyme, IgG, or the like)) is transferred from a stylus to a selected location on a surface by changing the polarity and/or magnitude of the bias of the stylus. In another example, at least one particle (e.g., protein molecule (e.g., β-LG, BSA, lysozyme, IgG, or the like)) is transferred from a selected location on a surface to a stylus by changing the polarity and/or magnitude of the bias of the stylus. In another example, at least one particle (e.g., protein molecule (e.g., β-LG, BSA, lysozyme, IgG, or the like)) is transferred from a stylus to a selected location on a surface by changing the polarity and/or magnitude of the bias of the stylus, and changing the distance between the stylus and the surface. In another example, at least one particle (e.g., protein molecule (e.g., β-LG, BSA, lysozyme, IgG, or the like)) is transferred from a selected location on a surface to a stylus by changing the polarity and/or magnitude of the bias of the stylus, and changing the distance between the stylus and the surface.

Another aspect of the present invention provides a method of selectively transferring a single particle (e.g., protein molecule) from a first location to a second location by providing a stylus having a bias, providing a surface, providing a single particle (e.g., protein molecule), and changing the bias of the stylus. For example, a single particle (e.g., protein molecule (e.g., β-LG, BSA, lysozyme, IgG, or the like)) is transferred from a stylus to a selected location on a surface by changing the bias of the stylus such that a single particle (e.g., protein molecule (e.g., β-LG, BSA, lysozyme, IgG, or the like)) is transferred. For instance, a single particle (e.g., protein molecule (e.g., β-LG, BSA, lysozyme, IgG, or the like)) is transferred from a stylus to a selected location on a surface by changing the polarity and/or the magnitude of the bias of the stylus such that a single particle (e.g., protein molecule (e.g., β-LG, BSA, lysozyme, IgG, or the like)) is transferred. In another example, a single particle (e.g., protein molecule (e.g., β-LG, BSA, lysozyme, IgG, or the like)) is transferred from a stylus to a selected location on a surface by changing the polarity and/or the magnitude of the bias of the stylus and changing the distance between the stylus and surface such that a single particle (e.g., protein molecule (e.g., β-LG, BSA, lysozyme, IgG, or the like)) is transferred.

In one example, at least one protein molecule (e.g., β-LG, BSA, lysozyme, IgG, or the like) is transferred from a stylus to a selected location on a surface by changing the bias from about +5.0 V to about −5.0 V for a duration sufficient to transfer the protein molecule(s). In another example, at least one protein molecule (e.g., β-LG, BSA, lysozyme, IgG, or the like) is transferred from a stylus to a selected location on a surface by changing the bias from about +0.5 V (e.g., from about +1.0 V to about +0.1 V) to about −4.5 V (e.g., from about −0.1 V to about −3.6 V, or from about −0.5 V to about −3.2 V) for a duration of about 1 millisecond (e.g., from about 0.001 milliseconds to about 10 milliseconds, from about 0.5 milliseconds to about 1.5 milliseconds, or from about 0.7 milliseconds to about 1.3 milliseconds). In one example, at least one protein molecule (e.g., β-LG, BSA, lysozyme, IgG, or the like)) is transferred from a stylus to a selected location on a surface by changing the bias from about +0.5 V (e.g., from about +1.0 V to about +0.1 V) to about −4.5 V (e.g., from about −0.1 V to about −3.6 V, or from about −0.5 V to about −3.2 V) for a duration of about 1 millisecond (e.g., from about 0.5 milliseconds to about 1.5 milliseconds, or from about 0.7 milliseconds to about 1.3 milliseconds) and increasing the distance between the stylus and the surface by about 0.2 nm (e.g., from about 0.05 nm to about 0.21 nm, or from about 0.05 nm to about 0.20 nm).

Another aspect of the present invention provides a method of removing at least one protein molecule (e.g., β-LG, BSA, lysozyme, IgG, or the like)) from a desired location on a surface comprising providing a stylus having a bias, providing a surface, providing at least one protein on the surface, and changing the bias such that at least one protein molecule is transferred from the surface to the stylus. In one example, at least one protein molecule (e.g., β-LG, BSA, lysozyme, IgG, or the like)) is transferred from a selected location on a surface to a stylus to a selected location on a surface by changing the bias from about −4.5 V (e.g., from about −3.6 V to about −0.1 V, or from about −3.2 V to about −0.5 V, or about −0.5 V)) to about +0.5 V (e.g., from about +1.0 V to about +0.1 V) for a duration sufficient to transfer the protein(s).

Another aspect of the present invention provides a method of selectively transferring at least one protein comprising providing a stylus having a bias, providing a surface, providing at least one protein, and changing the bias such that a single protein is transferred, wherein the protein has a mass of about 5 kDa. In several examples, the protein has a mass of at least 10 kDa (e.g., at least 15 kDa, at least 20 kDa, at least 50 kDa, or at least 100 kDa). In other examples, the protein has a mass of from about 5 kDa to about 200,000 kDa (e.g., from about 10 kDa to about 180,000 kDa, or from about 20 kDa to about 150,000 kDa). For instance, at least one protein molecule having a mass of at least 5 kDa is transferred from a stylus to a selected location on a surface by changing the bias from about +0.5 V (e.g., from about +1.0 V to about +0.1 V) to about −4.5 V (e.g., from about −0.1 V to about −3.6 V, or from about −0.5 V to about −3.2 V) for a duration of about 1 millisecond (e.g., from about 0.5 milliseconds to about 1.5 milliseconds, or from about 0.7 milliseconds to about 1.3 milliseconds). In another instance, at least one protein molecule having a mass of at least 15 kDa is transferred from a stylus to a selected location on a surface by changing the bias from about +0.5 V (e.g., from about +1.0 V to about +0.1 V) to about −4.5 V (e.g., from about −0.1 V to about −3.6 V, or from about −0.5 V to about −3.2 V) for a duration of about 1 millisecond (e.g., from about 0.5 milliseconds to about 1.5 milliseconds, or from about 0.7 milliseconds to about 1.3 milliseconds) and increasing the distance between the stylus and the surface by about 0.2 nm (e.g., from about 0.05 nm to about 0.21 nm, or from about 0.05 nm to about 0.20 nm).

An alternative aspect of this invention provides a method of selectively transferring a protein from one location to another location comprising providing a stylus having a bias, providing a surface, providing a protein, and changing the bias such that a single protein is transferred, wherein the protein comprises at least 50 amino acids (e.g., at least 60 amino acids, at least 75 amino acids, at least 100 amino acids, at least 150 amino acids, or at least 300 amino acids) wherein each residue is independently selected from alanine, cysteine, aspartic acid, glutamic acid, phenylalanine, glycine, histidine, isoleucine, lysine, leucine, methionine, asparagines, proline, glutamine, arginine, serine, threonine, selenocysteine, valine, tryptophan, and tyrosine, including variations on these amino acids and other similar molecules incorporated into proteins. In several examples, the protein comprises from about 100 amino acids to about 600 amino acids, each of which is independently selected from the abovementioned list of amino acids.

It is recognized that molecules transferable using the present methods are not restricted to these proteins or even biomolecules.

Another aspect of the present invention provides a method of selectively transferring at least one β-LG molecule or at least one BSA molecule from a first location to a second location comprising providing a stylus having a bias, providing a surface, providing at least one β-LG molecule or at least one BSA molecule, and changing the bias such that at least one β-LG molecule or at least one BSA molecule is transferred from the first location to the second location. For example, STM is used to selectively deposit a single β-LG molecule or a single BSA molecule on a surface or selectively remove a single β-LG molecule or a single BSA molecule from a surface by changing the bias of the stylus such that the β-LG molecule or BSA molecule is transferred from the stylus to a selected location on the surface or from a selected location on the surface to the stylus. In one example, a single β-LG molecule or a single BSA molecule is transferred from a stylus to a selected location on a surface by changing the polarity and/or magnitude of the bias of the stylus for a duration sufficient to transfer the β-LG molecule or the BSA molecule. In another example, a single β-LG molecule or a single BSA molecule is transferred from a selected location on a surface to a stylus by changing the polarity and/or magnitude of the bias of the stylus for a duration sufficient to transfer the β-LG molecule or the BSA molecule. In other examples, at least one β-LG molecule or at least one BSA molecule is transferred from a selected location on a surface to a stylus by changing the polarity and/or magnitude of the bias of the stylus, and changing the distance between the stylus and the surface. In still other examples, a single β-LG molecule or a single BSA molecule is transferred from a stylus to a selected location on a surface by changing the polarity and/or magnitude of the bias of the stylus, and changing the distance between the stylus and the surface.

Another aspect of the present invention provides a method of selectively transferring at least one protein molecule comprising providing a stylus having a bias, providing a surface, providing at least one protein molecule, and changing the polarity and/or magnitude of the bias such that the protein molecule(s) is transferred, wherein the protein molecule(s) has a positive net charge when subjected to a neutral buffered environment. Another aspect of the present invention provides a method of selectively transferring a protein comprising providing a stylus having a bias, providing a surface, providing a protein, and changing the polarity and/or magnitude of the bias such that a single protein is transferred, wherein the protein has a negative net charge when subjected to a neutral buffered environment. Exemplary proteins include β-LG, BSA, lysozyme, or IgG.

Another aspect of the present invention provides a method of selectively transferring a protein comprising providing a stylus having a bias, providing a surface, providing a protein, and changing the bias of the stylus such that a single protein is transferred, wherein the stylus comprises a conductive material. For example, the stylus comprises at least one metal, e.g., gold, silver, platinum, palladium, ruthenium, rhodium, osmium, iridium, tungsten, or combinations thereof. In other examples, the stylus comprises platinum and iridium. In other examples, the stylus comprises essentially platinum and iridium in any proportion. For instance, the stylus further comprises about 80 wt % (e.g., from about 70 wt % to about 90 wt %) of platinum and about 20 wt % (e.g., from about 30 wt % to about 10 wt %) of iridium.

Another aspect of the present invention provides methods of selectively transferring a protein from a stylus to a gold surface or from a gold surface to a stylus by providing a gold surface, providing a protein, providing a stylus having a bias, and changing the bias of the stylus such that a protein transfers from a stylus to a gold surface or from a gold surface to a stylus. Surfaces suitable for the present invention include any contour. However, surfaces suitable for use in the present invention include any surface that is suitable for S™ scanning. Such surfaces include those that are conducting or semiconducting. Examples of several surfaces include those comprising a conductor or a semiconductor. In other examples, a surface comprises gold, silver, platinum, copper, palladium, ruthenium, rhodium, osmium, tungsten, iridium, zinc, nickel, aluminum, iron, titanium, chromium, graphite, mercury, silicon, silicon dioxide, combinations thereof, or the like.

The change in bias can refer to a change in magnitude and/or polarity of a bias for a duration of time sufficient to transfer at least one particle (e.g., at least one protein molecule (e.g., at least one β-LG, BSA, lysozyme, IgG, or the like)). The change can be extended, i.e., more than 1 second, or the change can be temporary, i.e., 1 second or less. For example, a bias undergoes a change in magnitude and/or polarity that lasts for a fraction of a second (e.g., from about 0.25 milliseconds to about 2.5 milliseconds, from about 0.75 milliseconds to about 1.25 milliseconds, or from about 0.9 milliseconds to about 1.1 milliseconds) that constitutes a pulse. When the transfer of at least one particle (e.g., at least one protein molecule (e.g., at least one β-LG, BSA, lysozyme, IgG, or the like)) conveys the particle(s) from a stylus to a selected location on a surface, the change in bias lasts for a sufficient time to convey the particle(s) to the selected location on the surface (e.g., the bias change is temporary). When the transfer of at least one particle (e.g., protein molecule (e.g., β-LG, BSA, lysozyme, IgG, or the like)) conveys the particle(s) from a selected location on a surface to a stylus, the change in bias also lasts for a sufficient time to convey the particle(s) to the selected location on the surface (e.g., the bias change is temporary or extended). For example, when transferring several particles from a desired location or area of a surface to a stylus, the change in bias lasts at least for a time sufficient to raster the stylus over desired location or area of the surface or position the stylus over the particle(s).

In other examples, the magnitude of the bias is changed for a brief amount of time or an extended amount of time. For instance, the bias is changed from about +0.1 V to about −0.5 V for about 1 millisecond. In another instance, the bias is changed from about +0.1 V to about −0.8 V for about 1 millisecond.

As noted above, the amount of material that is transferred from one location to another location and the change in bias necessary to accomplish the transfer depends on the clearance, i.e., the distance between the stylus and the surface. For example, the clearance can be tuned to transfer a desired amount of material from one location to another (e.g., from a stylus to a surface or from a surface to a stylus). As such, the clearance can be tuned to facilitate the transfer. For example, the clearance can be increased or decreased to provide the transfer of a desired amount of material from a first location to a second location. Furthermore, the clearance can be increased or decreased to improve or exacerbate the precision of material deposition from a stylus onto a surface. For example, the clearance can be increased or decreased by as much as about 0.3 nm (e.g., up to about 0.25 nm, or up to about 0.20 nm) to improve or exacerbate the precision of material deposition from a stylus onto a surface.

Another aspect of the present invention provides a method of producing a biochip comprising using STM to selectively transfer at least one protein molecule from a first location (e.g., a stylus) to a second location (e.g., surface) comprising providing a stylus having a bias, providing a surface, providing at least one protein molecule, and changing the bias of the stylus such that at least one protein molecule is transferred.

According the methods of the present invention, designs can be created “top down” or “bottom up” wherein at least one particle is added to a surface to create a design, or at least one particle is removed from a surface to create a design.

### IV. Examples

Proteins were dissolved at a concentration of 1.0 μg/mL in 100 mM phosphate buffer (pH 7.0). Gold coated cover slips were employed as substrates, which were annealed at about 820° C. for two hours in order to attain atomically flat terraces as shown in FIGS. 1 and 2. A stylus made of Pt and Ir (Pt:Ir, 80:20 wt %) was cut manually and calibrated to make sure it was atomically sharp at its end. The stylus was then coated with biomolecules. The stylus was soaked in the buffer containing the proteins. No bias potential is needed to coat the stylus with the target biomolecules. The stylus was then removed and allowed to air dry. The STM tunneling current was set at about 0.1 nA. Transferring of the protein was accomplished using two modes as follows:

1. Scanning mode: In this mode, the protein coated tip was employed. The deposition was accomplished by scanning over an area, and removal or erasure of the proteins was accomplished by scanning over the same area with a changed bias. In the whole process, the tip was engaged in tunneling state and when the bias was changed, it was changed to a certain value that was maintained until the next change.

Using the protein coated Pt—Ir tip, the clean annealed gold sample illustrated in FIG. 1 was scanned using STM in a normal stable imaging mode at a bias set at +0.5 V. When the β-LG coated tip bias was set to −0.5 V, β-LG molecules were transferred evenly onto the gold surface when the tip was in scanning mode as illustrated in FIG. 2. The transferring rate is proportional to the bias magnitude and is dependent on the clearance. For depositing in scanning mode, the bias ranged from −0.1 V to −2.0 V.

2. Pulse mode: This mode was developed in order to deposit molecules according to a predefined pattern. A protein coated tip was approached to tunneling state, and then transfer of the protein was controlled by three factors: pulse bias, pulse period, and clearance. Clearance could be changed by the software manually; i.e. raise the tip by 0.2 nm. In this way, the tip was either raised or lowered in order to control the density of the deposited biomolecules on the substrate. By adjusting the additional clearance and pulse period and the bias, single molecule manipulation was achieved. In pulse mode, the bias change means the bias was changed from an initial value to another value that was held for a specific length of time and then it was returned to the initial value; i.e., the initial bias was −0.5 V, changed to the pulse value of −1.5 V for 1 millisecond, and then returned to the initial bias of −0.5 V.

The pulse mode was developed for precision patterning as demonstrated in FIGS. 3-5. By adjusting the clearance, bias magnitude and bias pulse period, single molecule manipulation was achieved. Referring to FIG. 3, a string “ACMA” of single β-lactoglobulin molecules was written with the pulse magnitude of −3.2 V. It was observed that tip bulk material was transferred when the bias is very high; i.e. for a Pt—Ir tip and gold surface, it is normally about ±4.0 V. However, no tip bulk material was observed to transfer with any smaller bias. With a bias smaller than ±4.0 V only protein molecules are transferred between the tip and substrate.

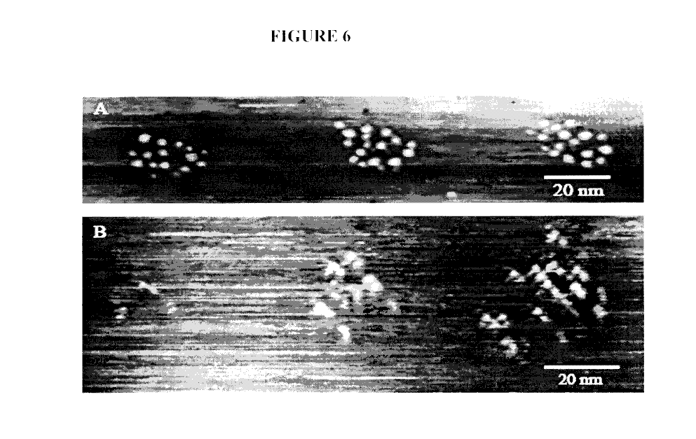

In another example shown in FIG. 6A, three nanopatterns of dozens of β-lactoglobulin molecules were deposited onto a gold surface with the release of three pulses of −3.0 V and 1 millisecond. In all three nano-fabrications, tips were lifted up by 0.2 nm when a pulse was released

In FIG. 6B, a series of nano-patterns of multiple β-LG molecules were deposited onto a gold surface. Each one corresponds to a bias pulse respectively but of different potentials. From left to right, the potential was decreased from −3.1 V to −3.3 V by a step of −0.1 V.

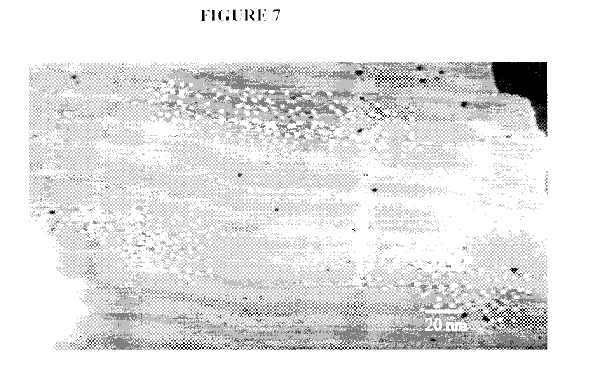

FIG. 7 shows another example where the top pattern consists of two nano-patterns deposited and overlapping each other using two pulses at −1.8 V and for 10 milliseconds. Two nano-patterns deposited separately are shown just below the first pattern.

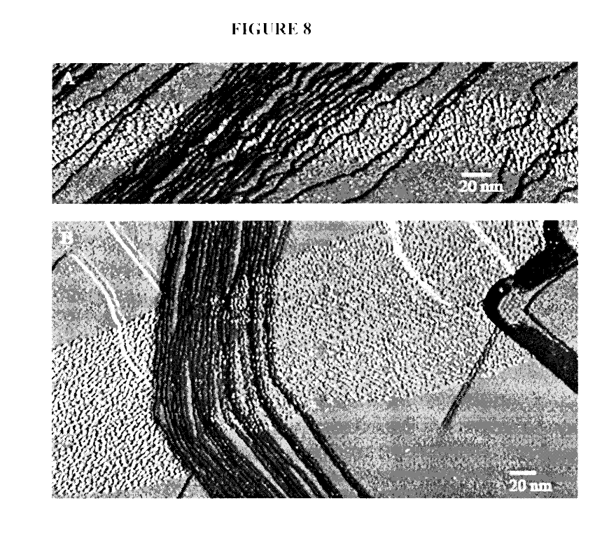

FIG. 8A shows another example of a long nano-band generated corresponding to the release of a pulse of −1.8 V for 50 milliseconds. FIG. 8B shows a wide nano-band generated by depositing three thin ones side by side.

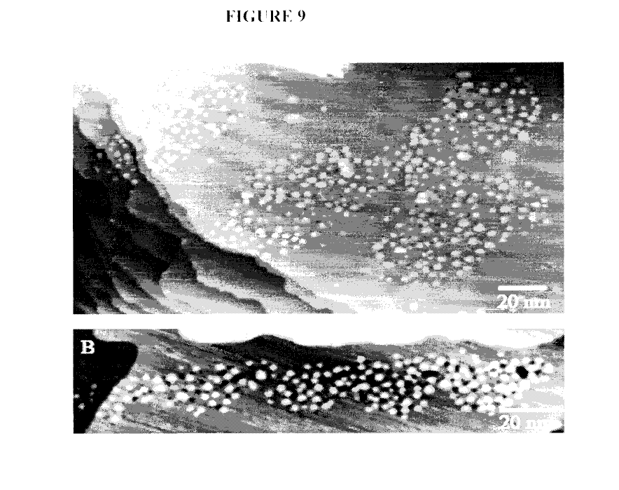

FIG. 9A shows four nano-patterns of multiple β-LG molecules deposited onto a gold surface. The specific shape of the formed nano-patterns is probably due to the shape of the tip. Each nano-pattern was formed from a single bias pulse of −2.0 V for 10 milliseconds, and each pulse resulted in a nano-pattern of a similar shape and size.

FIG. 9B shows a series of nano-patterns of multiple β-LG molecules deposited onto a gold surface. Each pattern corresponds to a bias pulse of the same duration but of different potentials. From left to right, the potential was decreased from −2.6 V to −3.4 V by an incremental step of −0.2 V.

The abovementioned examples can also be performed using BSA, which yields similar results.

### Other Embodiments

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims. For example, a scanning probe microscope capable of carrying out the methods of this invention can be used in place of a scanning tunneling microscope.

What is claimed is:

1. A method of transferring a material from a first location to a second location comprising the steps of:
providing a stylus having a bias;
providing a surface;
providing the material; and
changing the bias of the stylus such that the material is transferred from the first location to the second location.

2. A method of creating a design on a surface comprising:
selectively depositing a material on a surface comprising:
providing a stylus having a bias;
providing the material on the surface of the stylus; and
changing the bias of the stylus such that the material transfers from the stylus to the surface.

3. A method of removing a material from a surface comprising:
providing a stylus having a bias;
providing a surface comprising the material; and
changing the bias of the stylus such that the material is transferred from the surface to the stylus.

4. A method of transferring a material from a first location to a second location comprising the steps of:
providing a stylus;
submerging the stylus in a buffer solution containing the material;
drying the stylus;
applying a bias to the stylus;
providing a surface; and
changing the bias of the stylus such that the material is transferred from the first location to the second location.

5. The method of any one of claims 1-4, further comprising the step of scanning the surface with the stylus.

6. The method of any one of claims 1-5, further comprising the step of providing a clearance between the stylus and the surface such that a tunneling current is enabled to transfer the material.

7. The method of claim 6, further comprising the step of increasing or decreasing the clearance to change the density and range of the deposited material.

8. The method of claim 7, wherein the increase or decrease in the clearance is between about 0.05 nm and about 0.2 nm.

9. The method of any one of claims 1-8, wherein the bias is between about −5.0 V and +5.0 V.

10. The method of any one of claims 1-9, wherein the change in the bias comprises changing a polarity and/or a magnitude of the bias of the stylus for a duration sufficient to transfer the material.

11. The method of claim 2, wherein the bias of the stylus is changed from about +5.0 V to about −5.0 V.

12. The method of claim 3, wherein the bias of the stylus is changed from about −5.0 V to about +5.0 V.

13. The method of any one of claims 1-4, wherein the material is transferred by pulsing.

14. The method of any one of claims 1-13, wherein the bias is applied from about 0.001 millisecond to about 10 milliseconds.

15. The method of any one of claims 1-14, wherein the stylus comprises a conductive material.

16. The method of any one of claims 1-15, wherein the stylus comprises at least one metal.

17. The method of any one of claims 1-16, wherein the stylus comprises gold, silver, platinum, palladium, ruthenium, rhodium, osmium, iridium, tungsten, or combinations thereof.

18. The method of any one of claims 1-17, wherein the stylus comprises platinum and iridium.

19. The method of any one of claims 1-18, wherein the stylus comprises 80 wt % of platinum and 20 wt % of iridium.

20. The method of any one of claims 1-19, wherein the surface is semiconducting or conducting.

21. The method of any one of claims 1-20, wherein the surface comprises metal, glass, or a polymer.

22. The method of any one of claims 1-21, wherein the surface comprises gold, silver, copper, palladium, ruthenium, rhodium, osmium, tungsten, iridium, zinc, nickel, aluminum, iron, titanium, chromium, graphite, mercury, alloys thereof, silicon, or silicon dioxide.

23. The method of any one of claims 1-22, wherein the material comprises at least one protein, at least one particle, and/or at least one biomolecule.

24. The method of claim 23, wherein the protein has a mass of at least about 5 kDa.

25. The method of claim 23 or 24, wherein the protein comprises at least 50 residues.

26. The method of any one of claims 23-25, wherein the protein comprises at least 100 residues.

27. The method of any one of claims 23-26, wherein the protein has a negative charge, positive charge, or neutral charge when it is present in a neutral environment.

28. The method of any one of claims 23-27, wherein the protein is β-LG, BSA, lysozyme, or IgG.

29. A method of using a scanning tunneling microscope for transferring a material from a first location to a second location.

30. The method of any one of claims 1, 4, and 26, wherein the first location is a stylus and the second location is a surface.

31. The method of any one of claims 1, 4, and 26, wherein the first location is a surface and the second location is a stylus.

32. The method of any one of claims 29-31, wherein the material comprises at least one protein molecule, at least one particle, and/or at least one biomolecule.
